(19) United States
(12) Patent Application Publication
(10) Pub. No.: US 2023/0394489 A1
(43) Pub. Date: Dec. 7, 2023

(54) APPLICATION METHOD, SYSTEM, MEDIUM AND DEVICE OF DIGTIAL ASSETS BASED ON DIGTIAL PRODUCTS

(71) Applicants: Ming Zhou, Beijing (CN); Zhen Hua, Beijing (CN); Yongsheng Wang, Beijing (CN)

(72) Inventors: Ming Zhou, Beijing (CN); Zhen Hua, Beijing (CN); Yongsheng Wang, Beijing (CN)

(21) Appl. No.: 18/113,666

(22) Filed: Feb. 24, 2023

(30) Foreign Application Priority Data
Jun. 2, 2022 (CN) 202210623916.7

(51) Int. Cl. G06Q 20/40; G06Q 20/06

(52) U.S. Cl. CPC G06Q 20/405; G06Q 20/4014; G06Q 20/065

(57) ABSTRACT

The present application provides an application method, system, medium and device of digital assets based on digital product. This method includes: receiving a request from a requester for the display of a digital asset; sending a first identity authentication instruction to the owner of the digital asset according to the display request; receiving a first identity verification instruction sent by the owner of the digital asset according to the first identity authentication instruction; displaying the digital asset to the requester according to the first identity verification instruction, and recording the display of the digital asset to the requester on a transaction block of the blockchain platform. The application can not only improve the security performance of the transaction, but also improve the user experience.

### CROSS REFERENCE

The present application claims the benefit of the filing date of Chinese Patent Application No. 202210623916.7 filed on Jun. 2, 2022, the entire contents of which is incorporated herein by reference.

### TECHNICAL FIELD

The present application relates to the field of information technology, and specifically to an application method, system, medium and device of digital assets based on digital products.

### TECHNICAL BACKGROUND

A blockchain is a new application mode of computer technologies such as distributed data storage, point-to-point transmission, a consensus mechanism, and an encryption algorithm. The blockchain is essentially a decentralized database, as the underlying technology of Bitcoin, and is a string of data blocks generated through association by using a cryptographic method. Each data block includes information of a batch of network transactions, the information being used for verifying the validity of information of the data block (anti-counterfeiting) and generating a next data block.

In the process of realizing this application, the inventor found that digital assets are essentially digital information, and it is difficult for digital assets to achieve the same security as physical commodity transactions when they are displayed, and the security needs to be further improved.

### SUMMARY

In view of this, this application proposes an application method, system, medium and device of digital assets based on digital products to solve the above technical problems.

The present application provides an application method of digital assets based on digital products, which includes: receiving a request from a requester for the display of a digital asset; sending a first identity authentication instruction to the owner of the digital asset according to the display request; receiving a first identity verification instruction sent by the owner of the digital asset according to the first identity authentication instruction; displaying the digital asset to the requester according to the first identity verification instruction, and recording the display of the digital asset to the requester on a transaction block of the blockchain platform.

Optionally, after recording the display of the digital asset to the requester on a transaction block of the blockchain platform, the method further includes: obtaining the display duration of the digital asset; obtaining modes of operation of the digital asset by the requester and operating durations corresponding to modes of operation; calculating the requester's favorability for the digital asset according to the display duration, modes of operation and operating durations; sending an inquiry prompt to the requester when the favorability is greater than a predetermined threshold.

Optionally, after sending an inquiry prompt to the requester according to the favorability, of the method further includes: receiving a usage request from the requester; sending a second identity authentication instruction to the owner of the digital asset according to the usage request; receiving a second identity verification instruction sent by the owner of the digital asset according to the second identity authentication instruction and showing the requester the usage parameters and the quotation attached to the second identity verification instruction; receiving the consideration corresponding to the quotation sent by the requester, the blockchain platform will transfer the consideration to a first account block of the owner and transfer the digital asset to a second account block of the requester, and record the transfer of the digital asset from the owner to the requester on the transaction block.

Optionally, the usage parameters include the duration of use and/or the frequency of use.

Optionally, of the method further includes: monitoring the duration or frequency of use of the digital asset by the requester; issuing an extension reminder to the requester when the duration of use is longer than a predetermined duration or when the frequency of use is greater than a predetermined frequency; monitoring whether an extension request is received from the requester; if not, the digital asset is reset to the first account block when the duration or frequency of use is exhausted, and the transfer of the digital asset from the requester to the owner is recorded on the transaction block; if yes, and the consideration sent by the requester is received within a predetermined time, the blockchain platform transfers the consideration again to the owner's first account block and retains the digital asset in the requester's second account block and records the stay of the digital asset in the requester's second account block on the transaction block.

Optionally, after sending an inquiry prompt to the requester according to the favorability, of the method further includes: receiving the request for transfer from the requester; sending a third identity authentication instruction with a reference transfer fee to the owner of the digital asset according to the transfer request; receiving a third identity verification instruction sent by the owner of the digital asset according to the third identity authentication instruction, wherein the third identity verification instruction contains a final transfer fee, and displaying the final transfer fee to the requester; receiving the final transfer fee sent by the requester, the blockchain platform will transfer the final transfer fee to the first account block of the owner and transfer the digital asset to the second account block of the requester, and record the transfer of the digital asset from the owner to the requester on the transaction block.

Optionally, calculating the favorability of the requester for the digital asset according to the display duration, modes of operation, and operating durations further includes: determining the duration of the display and the weight coefficient of each modes of operation; calculating the product of each modes of operation and its corresponding operating durations; calculating the favorability of the digital asset according to the weight coefficient, the display duration and the respective product.

The present application also provides an application system of digital assets based on digital products, the system includes: a blockchain platform, which includes: a receiving unit for receiving a request from a requester for the display of a digital asset; an identity authentication unit for sending a first identity authentication instruction to the owner of the digital asset according to the display request; a display recording unit for receiving a first identity verification instruction sent by the owner of the digital asset according to the first identity authentication instruction; displaying the digital asset to the requester according to the first identity verification instruction, and recording the display of the digital asset to the requester on a transaction block of the blockchain platform.

The present application also provides a non-volatile computer storage medium, having a computer-executable program stored therein; the executable computer program is configured to an application method of digital assets based on digital products as described above.

The present application is also an electronic device, which includes: at least one processor; and a memory communicatively connected to at least one processor; the memory stores instructions executable by at least one processor, the instructions being executed by at least one processor to enable the at least one processor to execute an application method of digital assets based on digital products as described above.

The application method, system, media and device of digital assets based on digital products provided in this application send a first identity authentication instruction according to the display request of the requester. The blockchain platform displays digital assets to the requester according to the first identity verification instruction corresponding to obtained the first identity authentication instruction, increases the owner's identity verification step, and records all the processes. While ensuring the owner's right to know, it can improve the security performance of the transaction and enhance the user experience.

### BRIEF DESCRIPTION OF THE DRAWINGS

FIG. 1 is a flow diagram of an application method of digital assets based on digital products in the present application.

FIG. 2 is a block diagram of the structure of an application system of digital assets based on digital products in the present application.

FIG. 3 is a schematic block diagram of the structure of the electronic device in the present application.

### DETAILED DESCRIPTION OF EMBODIMENTS

The technical solution of this application is described in detail below in conjunction with the accompanying drawings and embodiments. The same parts are indicated by the same symbols in the drawings. It should be noted that the words “front”, “back”, “left”, “right”, “up” and “down” used in the following description refer to the directions in the attached drawings. The terms “inside” and “outside” refer to the direction toward or away from the geometric center of a particular part respectively.

FIG. 1 illustrates a flow diagram of an application method of digital assets based on digital products in the present application, as shown in FIG. 1, which provides an application method of digital assets based on digital products in the present application, it includes:
S100, receiving a request from a requester for the display of a digital asset.

Digital assets are non-monetary assets in the form of electronic data that are owned or controlled by an enterprise or individual, and held for sale in the course of daily activities or in the course of production.

Digital assets in the text include virtual digital products produced by computers and ID codes, and digital products uniquely correspond to ID codes.

Virtual digital products can be formed according to real digital products in the real world by retrieving their design files.

The ID code can be a cryptographic token key, which has a code string that is split into a series of code subsets. The code subset can contain one or more attributes of the digital product, which can be a color scheme, brand, shape, etc. The digital product can be headphones, cell phones, etc.
S200, sending a first identity authentication instruction to the owner of the digital asset according to the display request.

The owner of the digital asset owns ownership of the digital asset. In another embodiment, an identity authentication instruction is still sent to the current owner of the digital asset even if the digital asset is not in the current owner's account block.
S300, receiving a first identity verification instruction sent by the owner of the digital asset according to the first identity authentication instruction.

The first identity verification instruction can adopt cryptographic keys, cryptographic graphics, as well as other authentication forms, such as facial recognition.
S400, displaying the digital asset to the requester according to the first identity verification instruction, and recording the display of the digital asset to the requester on a transaction block of the blockchain platform.

Digital assets can be displayed in 2D, 3D, or video format, and users can choose according to their needs.

Digital assets can be displayed according to the internet of things, tablets, mobile phones and other mobile terminals.

The application method of digital assets based on digital products provided in this application sends a first identity authentication instruction according to the display request of the requester. The blockchain platform displays digital assets to the requester according to the first identity verification instruction corresponding to obtained the first identity authentication instruction, increases the owner's identity verification step, and records all the processes. While ensuring the owner's right to know, it can improve the security performance of the transaction and enhance the user experience.

In one of the embodiments, S400, after recording the display of the digital asset to the requester on a transaction block of the blockchain platform, further includes: S500, inquiry steps. The embodiment includes:
S510, obtaining the display duration of the digital asset.

The timing starts when the blockchain platform shows the digital assets to the requester and ends when the requester stops showing them.
S520, obtaining modes of operation of the digital asset by the requester and operating durations corresponding to modes of operation.

The modes of operation can be amplification, rotation, screen capture, etc., and the operating durations corresponding to each modes of operation is recorded.
S530, calculating the requester's favorability for the digital asset according to the display duration, modes of operation and operating durations.

In one embodiment, a weighted average method may be used to calculate the requester's favorability, including:
S531, determining the display duration T and the weights of modes of operation Ki;

For example, the weight of display duration T is A, and the weights corresponding to modes of operation Ki is Ci, i=1, 2 . . . n.
S532, calculating the product Q of modes of operation and its corresponding operation time ti.

Wherein, Q=Σᵢ₌₁ⁿKi*ti.
S533, calculating the favorability of digital assets F according to the weights, display time, and products.

F=T*A+Σᵢ₌₁ⁿKi*ti*Ci.
S540, sending an inquiry prompt to the requester when the favorability is greater than a predetermined threshold.

For example, if the favorability is greater than 85, it is considered that the requestor is more interested in the digital asset. In this case, the inquiry prompt is sent to the requester, which can be displayed to the requester in the form of a dialog box.

By calculating the favorability, targeted reminders can be made to facilitate transactions. It is also possible to obtain users' preferences through favorability, so as to improve the design of digital products, etc., making the digital products reasonable and more scientific and better meet the needs of users.

In one embodiment, S540, after sending an inquiry prompt to the requester according to the favorability, further includes: S550, using transaction steps, including:
S551, receiving a usage request from the requester;
S552, sending a second identity authentication instruction to the owner of the digital asset according to the usage request;
S553, receiving a second identity verification instruction sent by the owner of the digital asset according to the second identity authentication instruction, and showing the requester the usage parameters and the quotation attached to the second identity verification instruction.

The usage parameters include the duration of use and/or the frequency of use.
S554, receiving the consideration corresponding to the quotation sent by the requester, the blockchain platform will transfer the consideration to a first account block of the owner and transfer the digital asset to a second account block of the requester, and record the transfer of the digital assets from the owner to the requester on the transaction block.

When the requester accepts the owner's quotation, it sends a consideration corresponding to the quotation to the blockchain platform, which can be in the form of one or more of money, digital assets, or physical objects.

The requester and the owner can negotiate the price through the blockchain platform, and the transaction block will record the negotiation process.

When the requester needs to use digital assets, it also sends identity authentication instructions to the owners of digital assets, which can further improve the security of transactions.

In an embodiment, after S554, the application method of digital assets based on digital products, further includes:
S555, monitoring the duration or frequency of use of the digital asset by the requester;
S556, issuing an extension reminder to the requester when the duration of use is longer than a predetermined duration or when the frequency of use is greater than a predetermined frequency.

In an embodiment, the predetermined duration can be 90% of the usage duration, and the predetermined frequency is 85% of the usage frequency.
S557, monitoring whether an extension request is received from the requester;
S558, if not, the digital asset is reset to the first account block when the duration or frequency of use is exhausted, and the transfer of the digital asset from the requester to the owner is recorded on the transaction block;
S559, if yes, and the consideration sent by the requester is received within a predetermined time, the blockchain platform transfers the consideration again to the owner's first account block and retains the digital asset in the requester's second account block, and records the stay of the digital asset in the requester's second account block on the transaction block.

If only an extension request is received from the requester and the consideration is not received within the predetermined time, the digital asset is still reset to the first account block and the transfer of the digital asset from the requester to the owner is recorded on the transaction block.

By monitoring the duration or frequency of use of the digital asset by the requester, and adding a reminder to postpone, the transaction can be further promoted and the user experience can be improved while ensuring the transaction security.

In one embodiment, S540, after sending an inquiry prompt to the requester according to the favorability, further comprising: S560, transfer steps, including:
S561, receiving the request for transfer from the requester;
S562, sending a third identity authentication instruction with a reference transfer fee to the owner of the digital asset according to the transfer request.

The reference transfer fee is the price of the pre-sale digital assets made by the blockchain platform according to mega data. For example, the blockchain platform counts the prices of digital assets similar to the pre-sale digital asset and takes the median of the counted prices as the reference transfer fee.

The aforementioned quotation in the transaction step can also be used as a reference for the owner.
S563, receiving a third identity verification instruction sent by the owner of the digital asset according to the third identity authentication instruction, wherein the third identity verification instruction contains the final transfer fee, and displaying the final transfer fee to the requester;
S564, receiving the final transfer fee sent by the requester, the blockchain platform will transfer the final transfer fee to the first account block of the owner and transfer the digital asset to the second account block of the requester, and record the transfer of the digital asset from the owner to the requester on the transaction block.

In an embodiment, the final transfer fee sent by the owner may be a first transfer fee range containing a maximum and a minimum, and the requester sends a second transfer fee range. The final transfer fee sent by the requester to the blockchain platform is the maximum of the second transfer fee range. When the two transfer ranges overlap, the blockchain platform can directly confirm that the transaction is completed without asking the transaction parties.

The average of the two endpoints of the intersection range is taken as the final transfer fee, and the excess transfer fee is transferred back to the second account block of the requester.

For example, the first transfer fee range sent by the owner is [300,350], the second transfer fee range sent by the requester is [280,330], and the transfer fee 330 is paid to the blockchain platform.

The intersection range of the two transfer fee ranges is [300,330], so the final transfer fee is (300+330)/2=315. The blockchain platform transfers the excess transfer fee 15 back to the requester's second account block.

The consideration in the above transaction steps can also be used to form the consideration of the actual transaction by reference to this method.

By setting transfer steps, it can facilitate the flow of digital assets between users and facilitate transactions, while setting the identity verification function to improve the security of transactions.

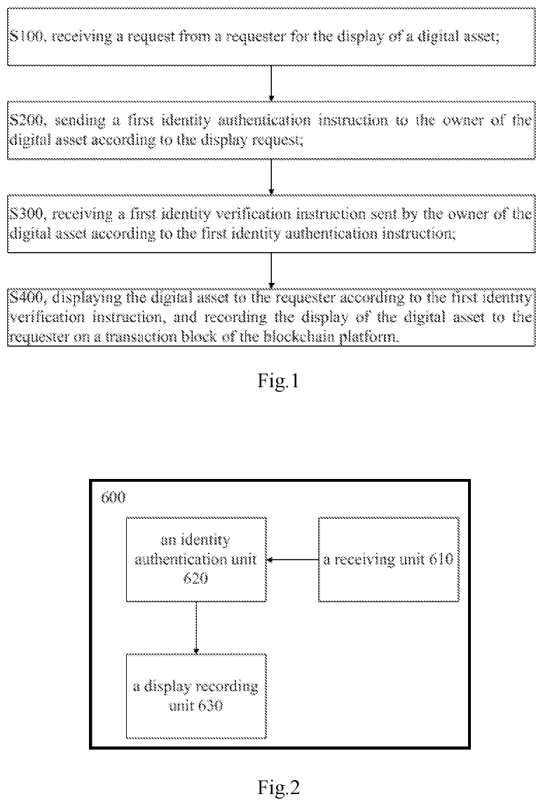

The present application also provides an application system of digital assets based on digital products, as shown in FIG. 2, which includes: a blockchain platform 600, it comprises:
a receiving unit 610 for receiving a request from a requester for the display of a digital asset;
an identity authentication unit 620 for sending a first identity authentication instruction to the owner of the digital asset according to the display request;
a display recording unit 630 for receiving a first identity verification instruction sent by the owner of the digital asset according to the first identity authentication instruction; displaying the digital asset to the requester according to the first identity verification instruction, and recording the display of the digital asset to the requester on a transaction block of the blockchain platform.

The application system of digital assets based on digital products provided in this application sends a first identity authentication instruction according to the display request of the requester. The blockchain platform displays digital assets to the requester according to the first identity verification instruction corresponding to obtained the first identity authentication instruction, increases the owner's identity verification step, and records all the processes. While ensuring the owner's right to know, it can improve the security performance of the transaction and enhance the user experience.

The present application also provides a non-volatile computer storage medium, having a computer-executable program stored therein, the executable computer program is configured to the application methods of digital assets based on digital products as described above.

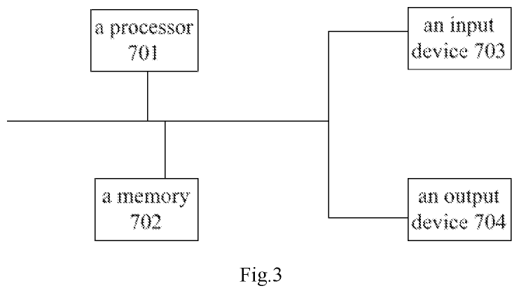

The present application also provides an electronic device, as shown in FIG. 3, it comprises:
at least one processor 701; and
a memory 702 communicatively connected to at least one processor 701; the memory 702 stores instructions executable by at least one processor 701, the instructions being executed by at least one processor 701 to enable at least one processor 701 to execute the application methods of digital assets based on digital products as described above.

The apparatus for performing the application methods of digital assets based on digital products as described above may also include: an input device 703 and an output device 704. The processor 701, the memory 702, the input device 703, and the output device 704 may be connected via a bus or other means.

As a non-volatile computer readable storage medium, the memory 702 can be used to store non-volatile software programs, non-volatile computer executable programs, and modules. The processor 701 executes various functional applications of the server and data processing by running the non-volatile software programs, instructions, and modules stored in the memory 702, which to realize the application methods of digital assets based on digital products in the above embodiments.

The memory 702 may include a stored program area and a stored data area. Wherein the stored program area may store an operating system, an application required for at least one function. The stored data area may store data created according to the application method of digital assets based on digital products. In addition, the memory 702 may include high-speed random access memory, and may also include non-volatile memory, such as at least one disk memory device, a flash memory device, or other non-volatile solid-state memory devices.

The input device 703 may receive input numeric or character information, and generate key signal inputs related to user Settings and functional controls related to the application method of digital assets based on digital products. The output device 704 may include a display device such as a display screen.

The one or more modules are stored in the memory 702, and when executed by the one or more processors, the application method of digital assets based on digital products in any of the above method embodiments is executed.

The product can execute the method provided in the embodiments of the present application, with the functional modules and beneficial effects corresponding to the execution of the method. For technical details not described in detail in this embodiment, please refer to the methods provided in this application embodiment.

The electronic devices of embodiments of the present application exist in a variety of forms, including but not limited to:
(1) Mobile communication devices: these devices are characterized by mobile communication functions and have the main goal of providing voice and data communication. Such terminals include: smart phones (such as iPhone), multimedia phones, functional phones, and low-end cell phones, etc.
(2) Ultra-mobile personal computer devices: these devices belong to the category of personal computers, with computing and processing functions, and generally also have the characteristics of mobile internet access. Such terminals include: PDA, MID and UMPC devices, such as iPad.
(3) Portable entertainment devices: these devices can display and play multimedia content. This category of devices includes: audio and video players (such as iPod), handheld game consoles, e-books, smart toys and portable car navigation devices.
(4) Server: a device that provides computing services. The composition of the server includes processor, hard disk, memory, system bus, etc. The server is similar to general computer architecture, but because it needs to provide highly reliable services, it has higher requirements in terms of processing power, stability, reliability, security, scalability, and manageability etc.
(5) Other electronic devices with data interaction functions.

Based on such an understanding, the technical solutions of this application essentially, or the part contributing to the conventional technology, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (ROM, read-only memory), a random access memory (RAM, random access memory), a magnetic disk, or an optical disc.

The apparatus embodiments described above are merely schematic, where the units described as separate components may or may not be physically separated, and the components displayed as units may or may not be physical units, i.e., may be located in one place or may be distributed to multiple network units. Part or all of the modules may be selected according to actual needs to achieve the purpose of the solution of the present embodiment. Those of ordinary skill in the art may understand and implement the solution of the present embodiment without creative effort.

Through the above description of the embodiments, it is clear for those skilled in the art that the embodiments may be implemented by means of software plus the required general-purpose hardware platform, or of course, may be implemented by means of hardware. Based on such understanding, the above technical solution in itself or the part which contributes to the prior art can be embodied in the form of software product. The computer software product can be stored in the computer readable storage medium such as ROM/RAM, disk, compact disc or the like, and include a number of instructions used to enable a computer equipment (which can be personal computer, server, network equipment or the like) to perform the methods described in various embodiments or some parts of the embodiments.

Finally, it should be noted that the above embodiments are only used to illustrate the technical solutions of the embodiments of the present application, and are not intended to limit the present disclosure. Although the embodiments of the present application has been described in detail with reference to the foregoing embodiments, those of ordinary skill in the art should understand that the technical solutions recorded in the foregoing various embodiments can still be modified, or some of the technical features thereof may be equivalently replaced. These modifications or replacements do not cause the essence of the corresponding technical solutions to deviate from the spirit and scope of the technical solutions of the embodiments of the present disclosure.

1. An application method of digital assets based on digital products, comprising:
receiving a display request from a requester for the display of a digital asset;
sending a first identity authentication instruction to the owner of the digital asset according to the display request;
receiving a first identity verification instruction sent by the owner of the digital asset according to the first identity authentication instruction;
displaying the digital asset to the requester according to the first identity verification instruction, and
recording the display of the digital asset to the requester on a transaction block of the blockchain platform.

2. The method as described in claim 1, wherein after recording the display of the digital asset to the requester on the transaction block of the blockchain platform, further comprising:
obtaining a display duration of the digital asset;
obtaining modes of operation of the digital asset by the requester and operating durations corresponding to modes of operation;
calculating the requester's favorability for the digital asset according to the display duration, modes of operation and operating durations;
sending an inquiry prompt to the requester when the favorability is greater than a predetermined threshold.

3. The method as described in claim 2, wherein after sending the inquiry prompt to the requester based on the favorability, further comprises:
receiving a usage request from the requester;
sending a second identity authentication instruction to the owner of the digital asset according to the usage request;
receiving a second identity verification instruction sent by the owner of the digital asset according to the second identity authentication instruction and showing the requester usage parameters and a quotation attached to the second identity verification instruction;
receiving consideration corresponding to the quotation sent by the requester, the blockchain platform will transfer the consideration to a first account block of the owner and transfer the digital asset to a second account block of the requester, and record the transfer of the digital asset from the owner to the requester on the transaction block.

4. The method as described in claim 3, wherein the usage parameters include a use duration and/or a use frequency.

5. The method as described in claim 4, further comprising:
monitoring the duration or frequency of use of the digital asset by the requester;
issuing an extension reminder to the requester when the duration of use is longer than a predetermined duration or when the frequency of use is greater than a predetermined frequency;
monitoring whether an extension request is received from the requester;
if not, the digital asset is reset to the first account block when the duration or frequency of use is exhausted, and the transfer of the digital asset from the requester to the owner is recorded on the transaction block;
if yes, and the consideration sent by the requester is received within a predetermined time, the blockchain platform transfers the consideration again to the owner's first account block and retains the digital asset in the requester's second account block and records the stay of the digital asset in the requester's second account block on the transaction block.

6. The method as described in claim 2, wherein after sending the inquiry prompt to the requester based on the favorability, further comprises:
receiving the request for transfer from the requester;
sending a third identity authentication instruction with a reference transfer fee to the owner of the digital asset according to the transfer request;
receiving a third identity verification instruction sent by the owner of the digital asset according to the third identity authentication instruction, wherein the third identity verification instruction contains a final transfer fee, and
displaying the final transfer fee to the requester;
receiving the final transfer fee sent by the requester, the blockchain platform will transfer the final transfer fee to the first account block of the owner and transfer the digital asset to the second account block of the requester, and record the transfer of the digital asset from the owner to the requester on the transaction block.

7. The method as described in claim 2, wherein according to the display duration, an operation mode and an operation duration, the requestor's favorability for the digital asset is calculated, it also includes:
determining the duration of the display and a weight coefficient of each mode of operation;
calculating the product of each mode of operation and its corresponding operating durations;
calculating the favorability of the digital asset according to the weight coefficient, the display duration and the respective product.

8. An application system of digital assets based on digital products, including a blockchain platform, comprising:
a receiving unit for receiving a request from a requester for the display of a digital asset;
an identity authentication unit for sending a first identity authentication instruction to the owner of the digital asset according to the display request;
a display recording unit for receiving a first identity verification instruction sent by the owner of the digital asset according to the first identity authentication instruction, and displaying the digital asset to the requester according to the first identity verification instruction, and recording the display of the digital asset to the requester on a transaction block of the blockchain platform.

9. An electronic device, it comprises:
at least one processor; and,
a memory communicatively connected to at least one processor; wherein:
the memory stores computer executable instructions executed by at least one processor, the instructions being executed by at least one processor to enable at least one processor to:
receive a display request from a requester for the display of a digital asset;
send a first identity authentication instruction to the owner of the digital asset according to the display request;
receive a first identity verification instruction sent by the owner of the digital asset according to the first identity authentication instruction;
displaying the digital asset to the requester according to the first identity verification instruction, and
record the display of the digital asset to the requester on a transaction block of the blockchain platform.

10. The device of claim 9, wherein the instructions enable at least one processor to, after recording the display of the digital asset to the requester on the transaction block of the blockchain platform:
obtain a display duration of the digital asset;
obtain modes of operation of the digital asset by the requester and operating durations corresponding to modes of operation;
calculate the requester's favorability for the digital asset according to the display duration, modes of operation and operating durations;
sending an inquiry prompt to the requester when the favorability is greater than a predetermined threshold.

11. The device of claim 10, wherein the instructions enable at least one processor to, after sending the inquiry prompt to the requester based on the favorability:
receive a usage request from the requester;
send a second identity authentication instruction to the owner of the digital asset according to the usage request;
receive a second identity verification instruction sent by the owner of the digital asset according to the second identity authentication instruction and showing the requester usage parameters and a quotation attached to the second identity verification instruction;
receive consideration corresponding to the quotation sent by the requester, the blockchain platform will transfer the consideration to a first account block of the owner and transfer the digital asset to a second account block of the requester, and record the transfer of the digital asset from the owner to the requester on the transaction block.

12. The method as described in claim 11, wherein the usage parameters include a use duration and/or a use frequency.

13. The device of claim 12, wherein the instructions enable at least one processor to:
monitor the duration or frequency of use of the digital asset by the requester;
issue an extension reminder to the requester when the duration of use is longer than a predetermined duration or when the frequency of use is greater than a predetermined frequency;
monitor whether an extension request is received from the requester;
if not, the digital asset is reset to the first account block when the duration or frequency of use is exhausted, and the transfer of the digital asset from the requester to the owner is recorded on the transaction block;
if yes, and the consideration sent by the requester is received within a predetermined time, the blockchain platform transfers the consideration again to the owner's first account block and retains the digital asset in the requester's second account block and records the stay of the digital asset in the requester's second account block on the transaction block.

14. The device of claim 10, wherein the instructions enable at least one processor to, after sending the inquiry prompt to the requester based on the favorability:
receive the request for transfer from the requester;
send a third identity authentication instruction with a reference transfer fee to the owner of the digital asset according to the transfer request;
receive a third identity verification instruction sent by the owner of the digital asset according to the third identity authentication instruction, wherein the third identity verification instruction contains a final transfer fee, and
display the final transfer fee to the requester;
receive the final transfer fee sent by the requester, the blockchain platform will transfer the final transfer fee to the first account block of the owner and transfer the digital asset to the second account block of the requester, and
record the transfer of the digital asset from the owner to the requester on the transaction block.

15. The device of claim 10, wherein the instructions enable at least one processor to calculate the requestor's favorability according to the display duration, an operation mode and an operation duration and further:
determine the duration of the display and a weight coefficient of each mode of operation;
calculate the product of each mode of operation and its corresponding operating durations;
calculate the favorability of the digital asset according to the weight coefficient, the display duration and the respective product.
